(19) United States
(12) Patent Application Publication
(10) Pub. No.: US 2023/0209424 A1
(43) Pub. Date: Jun. 29, 2023

(54) USER EQUIPMENT AND CORE NETWORK SIGNALING FOR RADIO ACCESS NETWORK SLICE BASED CELL RE-SELCTION

(71) Applicant: Apple Inc., Cupertino, CA (US)

(72) Inventors: Vivek G Gupta, San Jose, CA (US); Sridhar Prakasam, Fremont, CA (US)

(21) Appl. No.: 17/971,874

(22) Filed: Oct. 24, 2022

Related U.S. Application Data
(60) Provisional application No. 63/293,867, filed on Dec. 27, 2021.

(51) Int. Cl. H04W 36/08; H04W 76/20; H04W 48/18

(52) U.S. Cl. CPC H04W 36/08; H04W 76/20; H04W 48/18

(57) ABSTRACT

Techniques discussed herein can facilitate network slice based cell re-selection. One example aspect is a baseband processor of a user equipment (UE), including one or more processors configured to determine support for slice based cell re-selection (SCR), generate a SCR information element (IE) that indicates capability support for cell re-selection based on network slicing, generate a registration request comprising the SCR IE in response to determining support for SCR, receive a REGISTRATION ACCEPT message comprising a slice radio resource management information (SSRMI) in response to generating the registration request; and generate a REGISTRATION COMPLETE message in response to receiving the SSRMI.

### REFERENCE TO RELATED APPLICATIONS

This application claims the benefit of U.S. Provisional Application No. 63/293,867, filed on Dec. 27, 2021, the contents of which are hereby incorporated by reference in their entirety

### FIELD

The present disclosure relates to wireless technology including New Radio (NR) radio access network (RAN) slicing including a system and method for cell re-selection based on RAN slices.

### BACKGROUND

Mobile communication in the next generation wireless communication system, 5G, or new radio (NR) network will provide ubiquitous connectivity and access to information, as well as the ability to share data, around the globe. 5G networks and network slicing will be a unified, service-based framework, that will target to meet versatile, and sometimes conflicting, performance criteria. 5G networks will provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 is a resource diagram showing different slice, cell, and frequency allocations corresponding to different cell regions for slice based cell re-selection (SCR).

FIG. 3 is a fifth-generation of mobility telecommunications technology mobility management (5GMM) information element (IE) diagram showing a slice based cell re-selection (SCR) IE.

FIG. 4 is a fifth-generation of mobility telecommunications technology mobility management (5GMM) information element (IE) diagram showing a slice based cell re-selection (SCR IE) comprising one or more SCR IEs.

FIG. 5A is a slice radio resource management information (SRRMI) information element (IE) diagram showing a SRRMI IE comprising slice configuration information.

FIG. 5B is an alternative slice radio resource management information (SRRMI) information element (IE) diagram showing a SRRMI IE comprising slice configuration information.

FIG. 5C is an alternative slice radio resource management information (SRRMI) information element (IE) diagram showing a SRRMI IE comprising slice configuration information.

FIG. 6 is a signal flow diagram outlining an example of slice based cell re-selection (SCR) signaling between a user equipment (UE) and a network, in accordance with various aspects described herein.

FIG. 7A illustrates a flow diagram of a method for slice and frequency prioritization for slice based cell re-selection (SCR) by the UE.

FIG. 7B illustrates a flow diagram of a method for an alternative cell re-selection by a UE

FIG. 8 is a signal flow diagram outlining an example of a service request initiated by a user equipment (UE) to update slice radio resource management information (SRRMI) information.

FIG. 9 is a signal flow diagram outlining an example of a configuration update command initiated by an access and mobility function (AMF) to update slice radio resource management information (SRRMI).

FIG. 10 illustrates a flow diagram of an example method for slice based cell re-selection (SCR) signaling of a user equipment (UE).

FIG. 11 illustrates a flow diagram of an example method for slice based cell re-selection (SCR) signaling of an access and mobility function (AMF).

FIG. 12 illustrates a flow diagram of an example method for slice based cell re-selection (SCR) signaling of a base station (BS).

FIG. 13 illustrates a flow diagram of an example method for a service request initiated by a user equipment (UE) to update slice radio resource management information (SRRMI).

FIG. 14 illustrates a flow diagram of an example method for access and mobility function (AMF) signaling associated with a service request to update slice radio resource management information (SRRMI).

FIG. 15 illustrates a flow diagram of an example method for base station (BS) signaling associated with a service request to update slice radio resource management information (SRRMI).

FIG. 16 illustrates a flow diagram of an example method for user equipment (UE) signaling associated with a configuration update command to update slice radio resource management information (SRRMI).

FIG. 17 illustrates a flow diagram of an example method for a service request to update slice radio resource management information (SRRMI) initiated by an access and mobility function (AMF).

FIG. 18 illustrates a flow diagram of an example method for base station (BS) signaling associated with a configuration update command to update slice radio resource management information (SRRMI).

FIG. 19 illustrates an example of an infrastructure equipment, in accordance with various aspects disclosed.

FIG. 20 illustrates an example of a platform, in accordance with various aspects disclosed.

### DETAILED DESCRIPTION

5G or NR networks may use network slicing for the selection and allocation of resources suited to specific services. In some aspects, certain applications running on a user equipment (UE) may benefit from an allocation of network resources that support high data rates and throughputs. As such, network slicing includes resources from the Access Network and the Core Network (CN). Thus NR technologies could support radio access network (RAN) platforms meeting a wide range of performance features including throughput, capacity, latency, mobility, reliability, position accuracy, and the like. To meet the wide range of performance features, RAN slicing would benefit from supporting slice based cell re-selection (SCR) and slice based random access channel (RACH) configuration associated with slice resources. SCR can include various signaling and configuration that needs to be determined, including how slices are grouped, how slice priorities are determined, how slices are mapped to associated frequencies, how slices available in a cell and neighboring cells are grouped and associated priorities are communicated to the UE, signaling between an operation administration and maintenance (OAM) entity, an access and mobility function (AMF), the UE, and a base station (BS) to facilitate SCR, and UE access stratum (AS) to UE non-access stratum (NAS) communications to facilitate SCR.

Various aspects of the present disclosure are directed towards facilitating SCR. Mechanisms by which the OAM entity, AMF, UE, UE AS, UE NAS and BS interact to facilitate SCR are presented herein. Mechanisms by which network slices are grouped, prioritized, and mapped to associated frequencies to facilitate SCR are presented herein. Mechanisms presented herein allow the UE to perform cell re-selection based on slice priorities and availability across cells in a battery power efficient and optimized manner.

In some aspects, an OAM entity transmits a slice group configuration that may include slice specific RACH information, to a BS. The BS transmits a broadcast message including the information on slices available in a cell and neighboring cell, their grouping and priority information to a UE indicating network support for slice group and priority based cell reselection. In some aspects, the BS can also transmit a next generation (NG) setup request according to a NG application protocol (NGAP) including the slice group configuration comprised in slice radio resource management information (SRRMI) to an AMF. The AMF transmits a NG setup response according to a NGAP message, as such, the AMF is configured with the slice group configuration. In other aspects, the OAM entity transmits the slice group configuration directly to configure the AMF with slice group configuration directly, thereby avoiding NGAP signaling.

The UE, which includes a UE AS and UE NAS, generates a SCR information element (IE) that indicates capability support for cell re-selection based on network slicing. The SCR IE can be indicated by a single bit field in a fifth-generation of mobile telecommunications technology (5G) mobility management (MM) capability IE, for example. In other aspects, the SCR IE is indicated by a plurality of IEs including a slice group IE indicating UE support for slice grouping, a slice priority support IE indicating UE support for slice prioritization, and a slice radio resource management (SRRM) support IE indicating UE support for SRRM configurations. The SCR IE can further indicate support for SCR while the UE is in a radio resource control (RRC) idle (RRC_IDLE) state and RRC inactive (RRC_INACTIVE) state.

The UE transmits a registration request including the SCR IE to the BS which forwards the SCR IE to the AMF. In some aspects, the UE may optionally compute single network slice selection assistance information (S-NSSAI) with one or more of UE supported slices, UE supported slice priorities, or UE supported slice IDs. The AMF evaluates the SCR IE from the UE and evaluates the S-NSSAI from the UE if the S-NSSAI is available.

The AMF determines a complete S-NSSAI structure for inclusion in a slice radio resource management information (SRRMI) IE. The SRRMI includes a number of S-NSSAIs corresponding to a number of slices, S-NSSAI value, a S-NSSAI group ID, and a S-NSSAI priority, all of which are associated with the number of S-NSSAIs. Furthermore, the AMF determines radio resource management (RRM) information of the S-NSSAI including a number of frequencies supported by the number of S-NSSAI and associated frequency values and frequency priorities. The SRRMI are determined on a per-cell basis. The AMF either constructs the complete S-NSSAI structure based on the UE SCR IE and S-NSSAI information if the UE determined S-NSSAI information, or the AMF constructs the complete S-NSSAI structure based on the UE SCR IE and AMF network information.

The AMF transmits a REGISTRATION ACCEPT message to the UE through the BS including the SRRMI IE with S-NSSAI information according to the aspects discussed above. After receiving the SRRMI IE from the AMF, the UE NAS communicates the SRRMI IE to the UE AS. The UE applies configuration information according to the SRRMI IE from the AMF without any further communication from the network. In response to receiving the REGISTRATION ACCEPT message, the UE transmits a REGISTRATION COMPLETE message to the AMF through the BS acknowledging the REGISTRATION ACCEPT message.

One or more of the UE or AMF determine S-NSSAI grouping information and associated S-NSSAI prioritization. The S-NSSAI grouping information can be determined by one or more of grouping network slices available on a same frequency together, or grouping network slices in a same tracking area (TA) or registration area (RA) together. Slices in a same S-NSSAI group can have the same priority, and the slice priority can become the S-NSSAI priority for the S-NSSAI group. A S-NSSAI group ID associated with the S-NSSAI group can be determined from the SCR of the UE and subscription information of the UE. A S-NSSAI can belong to only one group or no group.

Slice priority assignment to determine the S-NSSAI priority can be based on various factors that include S-NSSAI configuration of the UE and a priority of the S-NSSAI associated with a home public land mobility network (HPLMN) status or visited public land mobile network (VPLMN) status of the UE. The various factors can further include active applications running on the UE or protocol data unit (PDU) session information and associated available network slices, or a priority of an active application running on the UE and user plane traffic associated with the UE. The various factors can further include network slice overload information in the TA or RA, or a S-NSSAI inclusion mode.

The UE can initiate a service request with the AMF according to aspects described above to establish a radio bearer and update the UE's SRRMI data if the SRRMI data has changed. Furthermore, the AMF can initiate a configuration update command to update the UE's SRRMI data when the AMF determines that the SRRMI data has changed. After the UE applies configuration information according to the SRRMI received by the UE AS, the UE can perform slice based cell re-selection. As such, the UE is enabled to perform cell re-selection based on slice priorities and slice availability across cells in a battery power efficient and optimized manner.

Additional aspects and details of the disclosure are further described below with reference to figures.

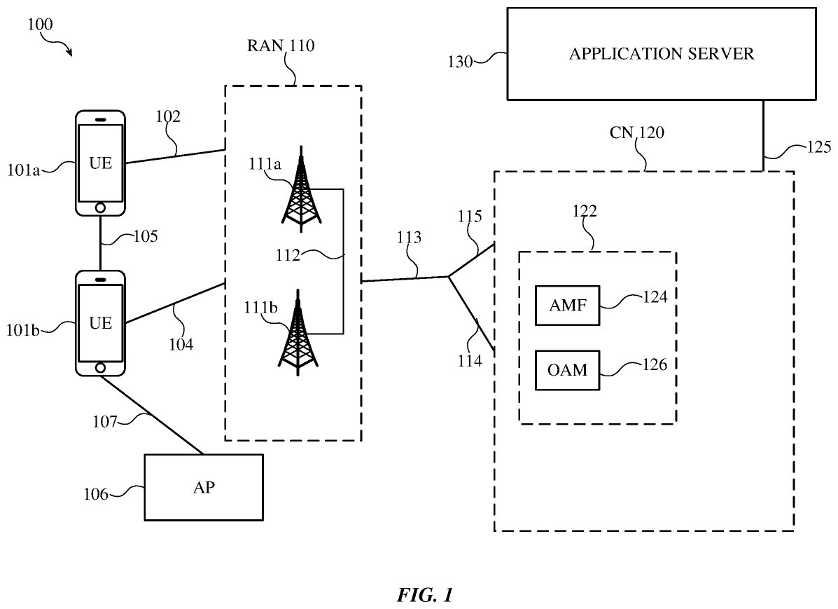

FIG. 1 illustrates example architecture of a wireless communication system 100 of a network that includes UE 101a and UE 101b (collectively referred to as “UEs 101” or “UE 101”), a radio access network (RAN) 110, and a core network (CN) 120. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system 100, and the term “E-UTRAN” or the like can refer to a RAN 110 that operates in an LTE or 4G system 100. The UEs 101 utilize connections (or channels) 102 and 104, respectively, each of which comprises a physical communication interface/layer.

Alternatively, or additionally, the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be connected via non-ideal backhaul, one providing NR access and the other one providing either E-UTRA for LTE or NR access for 5G, for example.

Alternatively, or additionally, UEs 101 can be configured in a CA mode where multiple frequency bands are aggregated amongst CCs to increase the data throughput between the UEs 101 and the nodes 111a, 111b. For example, UE 101a can communicate with node 111a according to the CCs in CA mode. Furthermore, UE 101a can communicate with nodes 112 in a DC mode simultaneously and additionally communicate with nodes 112 in the CA mode.

In this example, the connections 102 and 104 are illustrated as an air interface to enable communicative coupling. In aspects, the UEs 101 can directly exchange communication data via a ProSe interface 105. The ProSe interface 105 can alternatively be referred to as a sidelink (SL) interface 105 and can comprise one or more logical channels.

The RAN 110 can include one or more access nodes or RAN nodes 111a and 111b (collectively referred to as “RAN nodes 111” or “RAN node 111”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS) 111, next generation base station (gNBs), RAN nodes, evolved next generation base station (eNBs), NodeBs, RSUs, Transmission Reception Points (TRxPs) or TRPs, and so forth.

In aspects where the wireless communication system 100 is a 5G or NR system, nodes 112 can be described as the interface 112 and can be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120.

The RAN 110 is shown to be communicatively coupled to a core network—in this aspect, CN 120. The CN 120 can comprise a plurality of network elements 122, which are configured to offer various data and telecommunication services to customers/subscribers (e.g., users of UEs 101) who are connected to the CN 120 via the RAN 110.

Generally, the application server 130 can be an element offering applications that use IP bearer resources with the core network (e.g., Universal Mobile Telecommunications System Packet Services (UMTS PS) domain, LTE PS data services, etc.). The application server 130 can also be configured to support one or more communication services (e.g., VoIP sessions, PTT sessions, group communication sessions, social networking services, etc.) for the UEs 101 via an evolved packet core (EPC) of the CN 120.

The CN 120 can be a 5GC (referred to as “5GC 120” or the like), and the RAN 110 can be connected with the CN 120 via an NG interface 112. In embodiments, the NG interface 112 can be split into two parts, a Next Generation (NG) user plane (NG-U) interface 114, which carries traffic data between the RAN nodes 111 and a User Plane Function (UPF), and the 51 control plane (NG-C) interface 115, which is a signaling interface between the RAN nodes 111 and Access and Mobility Functions (AMFs) 124. The CN 120 can also be a 5GC 120. The core network can include an Operation Administration and Maintenance (OAM) entity 126 that can administrate operations between a UE 101, RAN 110, and the CN 120.

System 100 can include protocol layers including one or more of Physical layer (PHY), Media Access Control layer (MAC), Radio Link Control layer (RLC), Packet Data Convergence Protocol layer (PDCP), Service Data Adaptation Protocol (SDAP), Radio Resource Control layer (RRC), and Non-Access Stratum (NAS) layer, in addition to other higher layer functions. The protocol layers can include one or more service access points that can provide communication between two or more protocol layers.

The NAS can form the highest stratum of the control plane between the UE 101 and the AMF 124. The NAS can support the mobility of the UEs 101 and the session management procedures to establish and maintain IP connectivity between the UE 101 and other systems. The AMF 124 can provide control plane functionality within the CN 120 including registration management, connection management, reachability management, and mobility management.

In NR implementations, an application layer signaling protocol (AP) can be an NG application protocol layer (NGAP or NG-AP) for the NG interface 113 defined between the NG-RAN node 111 and the AMF 124, or the AP can be an Xn application protocol layer (XnAP or Xn-AP) for the Xn interface that is defined between two or more RAN nodes 111. The OAM entity 126 can communicate, among other things, slice group configuration information, random access channel (RACH) information, and NGAP information.

### Slice Based Cell Re-Selection

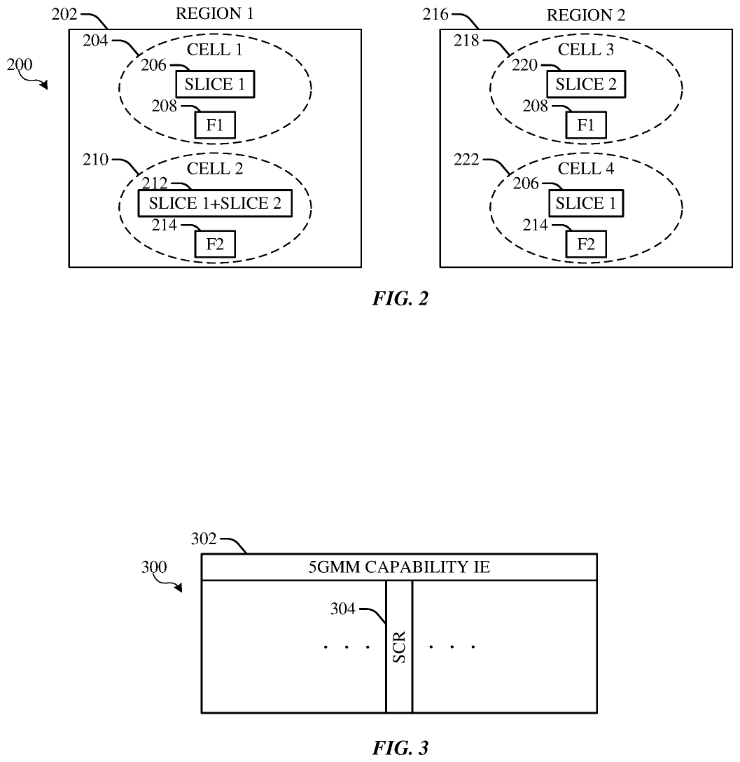

FIG. 2 is a resource diagram 200 showing different slice, cell, and frequency allocations corresponding to different cell regions for slice based cell re-selection (SCR). The resource diagram 200 depicts two different regions, region 1 202 and region 2 216. Each region can comprise one or more cells, for example cell 1 204 and cell 2 210 corresponding to region 1 202, and cell 3 218 and cell 4 222 corresponding to region 2 216. Each cell has an associated slice and/or slice group, slice group priority, and corresponding frequency assignments and priorities.

The slices can be configured to suit specific applications such as enhanced mobile broadband (eMBB), ultra-reliable low latency communications (URLLC), massive machine type communications (mMTC), vehicle-to-everything (V2X), internet of things (IoT), and the like. As such, either a UE 101, an AMF 124, or the UE 101 and AMF 124 can configure slices, slice groups, slice priorities, and associated frequencies to suit UE 101 application and network needs.

When a UE 101 is in a region, the UE 101 can select or re-select a cell, slice, and frequency suited to the UE 101 application use. For example, the UE 101 can connect to cell 1 204 and slice 1 206 supported by frequency 1 (F1) 208. If the UE 101 re-selects to cell 2 210, the UE 101 needs to configure a slice priority to network resources. For example, slice 2 210 may support slice 1 206 and slice 2 220 on frequency 2 (F2) 214. However, slice 1 206 may be prioritized over slice 2 220 in cell 2, and thus the UE 101 can configure slice 1 206 resources when connecting to cell 2 210. Alternatively, slice 1 and slice 2 may be a slice group 212 with a highest configured priority, and the UE 101 can configure the slice group 212 when connecting to cell 2.

When the UE 101 moves to region 2 216, slice 2 220 is supported by F1 208 in cell 3 218 and slice 1 206 is supported by F2 214 on cell 4 222, however there are no slice groups supported in region 2 216. Thus the example scenario depicts how different slices can be supported by different frequencies, slices may be available in certain regions, where multiple slices are available in a region or a cell, some slices may be prioritized over another, and slice groups may be supported in certain cells or regions and unsupported in other cells or regions. The number of slices, slice groups, slice priorities, and associated frequencies can collectively be referred to as slice radio resource management information (SRRMI).

With the various permutations of SRRMI associated with cells and regions, slice configuration and signaling is required for a network (e.g. CN 120) and UE 101 to establish communications according to the SRRMI. As such, various aspects of the present disclosure describe facilitation of SCR including signaling between network entities and mechanisms by which slices are configured so that the UE 101 can select the cell and frequency that can support the highest priority slice for the UE's 101 application.

FIG. 3 is a fifth-generation of mobility telecommunications technology mobility management (5GMM) information element (IE) diagram 300 showing a SCR IE.

One aspect in determining the SRRMI includes determining the SCR capability of the UE 101. As such, a 5GMM capability IE 302 can include a SCR IE 304 that indicates the UE's 101 support for SCR. In some aspects the UE 101 determines its SCR capability, and indicates its capability by configuring the SCR IE 304 with a single bit. For example, a bit value of “1” of the SCR IE 304 indicates the UE 101 supports SCR and a bit value of “0” of the SCR IE 304 indicates that the UE 101 does not support SCR. In some aspects, the 5GMM capability IE is a type 4 information element with at least 6 octets and maximum length of 15 octets. In other or similar aspects, the SCR IE 304 is comprised in octet 6 of the 5GMM capability IE.

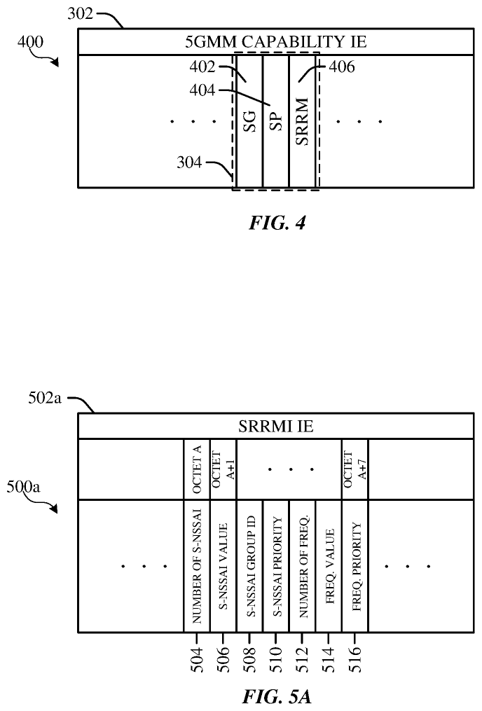

In alternative aspects, the SCR IE 304 can comprise one or more SCR IEs. FIG. 4 is a 5GMM IE diagram 400 showing a SCR IE 304 comprising one or more SCR IEs. The one or more SCR IEs can include a slice grouping support (SG) IE 402 indicting that the UE 101 supports slice grouping. The one or more SCR IEs can include a slice priority support (SP) IE 404 indicating that the UE 101 supports slice priorities for individual slices and or groups of slices. The one or more SCR IEs can include a slice radio resource management (SRRM) IE 406 indicating that the UE 101 supports slice radio resource management (RRM) configurations including frequency information, mapping of slices to frequencies, and priorities of the frequencies. As such, the SCR IE 304 can include one or more of the SG IE 402, the SP IE 404, or the SRRM IE 406. The SG IE 402, the SP IE 404, or the SRRM IE 406 can be indicated by single bits respectively.

The SCR IE 304 can also indicate that the UE 101 supports SCR while the SCR is in a RRC_IDLE or RRC_INACTIVE state. After the UE 101 determines its SCR capability, the UE 101 generates the 5GMM capability IE 302 comprising the SCR IE 304 according to the aspects described above.

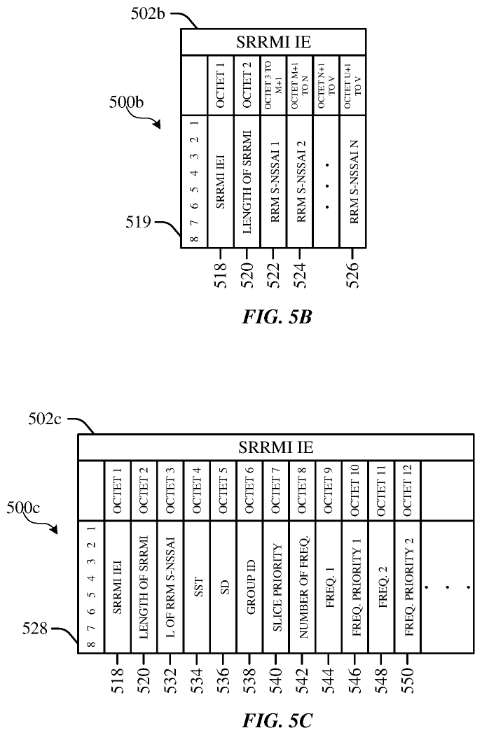

FIG. 5A is a SRRMI IE diagram 500a showing a SRRMI IE 502a comprising slice configuration information.

Either the UE 101, the AMF 124, or the UE 101 and AMF 124 can determine slices, slice group configuration and priority information and accordingly generate a SRRMI IE 502a. A network slice, or a slice, is identified by a single network slice specification assistance information (S-NSSAI). In some aspects the S-NSSAI is a concatenation of one or more of a slice/service type (SST) or a slice differentiator (SD). The SST can refer to the features and services associated with the slice and the slices expected behavior, and can be indicated by up to 8 bits. The services can include eMBB, URLLC, mMTC, V2X, IoT, and the like. The SD can differentiate between slices that have the same SST value for use with different subscriber groups using the same type of SST, and can be indicated by up to 24 bits. More than one S-NSSAI can be referred to as a network slice specification assistance information (NSSAI).

The SRRMI IE 502a can include one or more S-NSSAI IEs describing additional slice information. The one or more S-NSSAI IEs can include: a number of S-NSSAI IE 504 identifying the number of S-NSSAI for a cell, a S-NSSAI value IE 506 identifying a value for the number of S-NSSAI or a group of NSSAI, a S-NSSAI group ID IE 508 identifying a group ID for a group of S-NSSAI, and a S-NSSAI priority IE 510 assigning a prioritization for the number of S-NSSAI. The S-NSSAI IEs can further include radio resource management (RRM) information including a number of frequencies IE 512 identifying the number of frequencies that support a S-NSSAI or S-NSSAI group, a frequency value IE 514 identifying the frequency value supported by the S-NSSAI or S-NSSAI group, and a frequency priority IE 516 identifying a priority for the frequencies that support the S-NSSAI or S-NSSAI group.

In other aspects, the S-NSSAI group ID IE 508 and S-NSSAI priority IE 510 are comprised in a S-NSSAI IE where the S-NSSAI IE can be a type 4 information element comprising one or more of a length of S-NSSAI IE content, SST information, SD information, HPLMN SST mapping information, HPLMN SD mapping information, slice group ID, and slice priority information. In similar or other aspects, the slice group ID is comprised in octet 11 of the S-NSSAI IE and the slice priority information is comprised in octet 12 of the S-NSSAI IE. The group ID can contain an 8-bit slice group identifier for which the S-NSSAI belongs. The group ID values can range from 1 to 7 where a value of 0 specifies that the S-NSSAI does not belong to any group, and all other values are reserves. S-NSSAI of the same group ID can have the same value of slice priority. The slice priority information comprises the priority of the S-NSSAI which can range from 1-7, where a value of 0 specifies that the S-NSSAI is not associated with any priority, and all other values are reserved.

The SRRMI IE 502a can correspond to a cell, in the case of multiple cells, SRRMI IE 502a may be generated on a per cell basis. Determination of the SRRMI IE 502a can be based on the UE 101 capability information in the SCR IE 304. In some aspects the UE 101 determines the SRRMI IE 502a or a subset of the SRRMI IE 502a based on the SCR IE 304. In some aspects the AMF 124 determines the SRRMI IE 502a based on the SCR IE 304, or determines the SRRMI IE 502a based on the SCR IE 304 and a SRRMI IE 502a from the UE 101.

The UE 101 and or AMF 124 can determine single network slice specific assistance (S-NSSA) grouping information by various means. The S-NSSA grouping information corresponds to the number of S-NSSAI IE 504 and S-NSSAI group ID IE 508. In some aspects, the S-NSSA grouping information is determined by grouping network slices that are available on the same frequency together. For example, Slice 1 206 and Slice 2 220 comprising the slice group 212 in cell 2 210 of FIG. 2 are available on F2 214. Because Slice 1 206 and Slice 2 220 are available on the same frequency F2 214, they form slice group 212.

To increase network efficiency, cells are grouped together into Tracking Areas (TA), and one or more TA can be assigned to a UE 101 as a registration area (RA) where the RA is used for the network to search for the UE 101 and for the UE 101 to report its location. In some aspects, the S-NSSA grouping information is determined by grouping network slices available on the same frequency and inside the same TA or RA together. The S-NSSAI group ID associated with the determined S-NSSA grouping information can be based on SCR capability information from the UE 101 and a subscription information of the UE 101.

S-NSSA slice prioritization associated with the S-NSSA grouping information can be determined by various means. The S-NSSA slice prioritization is associated with the S-NSSAI priority IE 510. In some aspects, slices in a group can have the same priority where the slice priority becomes the slice group priority, such as the S-NSSAI priority. For example, slice 1 206 and slice 2 220 in cell 2 210 of FIG. 2 can have the same priority and form slice group 212 where the slice group 212 priority is the same as slice 1 206 and slice 2 220 priorities.

In other aspects, S-NSSA slice prioritization can be based on UE 101 configured S-NSSAI resources and their priorities as related to a home public land mobile network (HPLMN) status or a visited public land mobile network (VPLMN) status of the UE. For example, the S-NSSA slice prioritization would be related to the public land mobile network (PLMN) that the UE 101 is currently based (home or visited).

In other aspects, the S-NSSA prioritization can be based on active applications running on the UE 101 including applications that may be impacted by a requested S-NSSAI. A requested S-NSSAI can be a S-NSSAI that the UE 101 requested in a RRC signaling and or a NAS registration request where the network validates and uses the requested S-NSSAI.

In other aspects, the S-NSSA prioritization can be based on a protocol data unit (PDU) session information and associated slices, for example allowed S-NSSAI. An allowed S-NSSAI can be S-NSSAI assigned by the network and are valid in a RA or in a PLMN of a given access type. The UE 101 can establish PDU sessions associated with the allowed NSSAI over a plurality of network slices.

In other aspects, the S-NSSA prioritization can be based on a relative priority of applications and user plane traffic, or user preferences and associated configuration. In some aspects, the S-NSSA grouping information is decided by the UE 101 or in conjunction between the UE 101 and AMF 124 where subscription information and slice overload information in a TA or RA are the basis of S-NSSA prioritization.

In other aspects, the S-NSSA prioritization can be based on a S-NSSAI or NSSAI inclusion mode. Such as a S-NSSAI or NSSAI inclusion mode A, mode B, mode C, or mode D. The S-NSSAI inclusion mode can be indicated in a S-NSSAI or NSSAI inclusion mode IE from the AMF 124 to the UE 101, or decided by the UE 101 and can indicate information regarding UE 101 slice operation in a PLMN or stand-alone non-public network (SNPN).

In other aspects, the S-NSSA prioritization can be based on a RACH configuration where a slice-specific RACH resource pool is configured on a per slice of per slice group basis. A slice-specific RACH parameter prioritization can be configured on a per slice or per slice group basis.

The S-NSSAI prioritization can be based on one or more of the aspects discussed above. Aspects of FIGS. 3-5 discussed above provide a basis for describing UE 101 SCR capability and SRRMI to accomplish slice configuration for UE 101 and network slice based communications. Mechanisms described below adopt the above described IEs in signaling to establish slice based communications between the UE 101 and the network.

FIG. 5B is an alternative SRRMI IE diagram 500b showing a SRRMI IE 502b comprising slice configuration information.

Similar to the SRRMI IE diagram 500a of FIG. 5A, alternative SRRMI IE diagram 500b shows a SRRMI IE 502b with the purpose of identifying a collection of S-NSSAI as well as corresponding group configuration, priority, and associated RRM information. The SRRMI IE 502b can be a type 4 information element with a minimum of 4 octets, wherein alternative SRRMI IE diagram 500b shows octet 1 through octet V. The SRRMI IE 502b comprises various IEs including one or more of a SRRMI information element identifier (IEI) 518 to identify the SRRMI IE 502b, a length of SRRMI IE 520 indicating a length of the contents comprised in the SRRMI IE 502b, and includes various RRM S-NSSAI IEs.

An example of RRM S-NSSAI IEs includes, a RRM S-NSSAI 1 522 associated with octet 3 to octet M+1, where RRM S-NSSAI 1 522 includes relevant RRM information for S-NSSAI 1. Subsequently, if there are more S-NSSAI, they can be indicated by additional RRM S-NSSAI, for example, RRM S-NSSAI 2 524 from octet M+1 to octet N is generated with relevant RRM information for RRM S-NSSAI 2 524, as well as any additional RRM information for S-NSSAI as indicated by RRM S-NSSAI N 526 from octet U+1 to octet W.

The IEs of SRRMI IE 502b can include up to 8 bits as represented by bits 519. The RRM can include information as summarized in FIG. 5A such as a number of frequencies identifying the number of frequencies that support the S-NSSAI or S-NSSAI group, a frequency value identifying the frequency value supported by the S-NSSAI or S-NSSAI group, and a frequency priority identifying a priority for the frequencies that support the S-NSSAI or S-NSSAI group.

As such, in some examples, SRRMI IE 502b can indicate RRM information for a plurality of S-NSSAI. Additionally, SRRMI IE 502b can be used in conjunction with the S-NSSAI IE discussed previously where the S-NSSAI group ID IE 508 and S-NSSAI priority IE 510 are comprised in the S-NSSAI IE rather than the SRRMI IE 502b.

FIG. 5C is an alternative SRRMI IE diagram 500c showing a SRRMI IE 502c comprising slice configuration information.

Like SRRMI IE 502b, SRRMI IE 502c can be a type 4 information element with a minimum of 4 octets and can include group, priority, and RRM information for slices. The IEs of SRRMI IE 502c can include up to 8 bits as represented by bits 528. The SRRMI IE 502c can include one or more IEs including the SRRMI IEI 518 in octet 1, the length of SRRMI IE 520 in octet 2, a length of RRM S-NSSAI IE 532 in octet 3 indicating the length of S-NSSAI RRM associated data, SST IE 534 at octet 4, SD IE 536 at octet 5, and various RRM information for the S-NSSAI. The SST IE 534 and the SD IE 536 are associated with the RRM information for the S-NSSAI.

The RRM information for the S-NSSAI can include one or more of a group ID 538 at octet 6 which corresponds to the S-NSSAI group ID IE 508, of FIG. 5A, a slice priority IE 540 at octet 7, which corresponds to the S-NSSAI priority IE 510 of FIG. 5A, a number of frequencies IE 542 at octet 8 which corresponds to number of frequencies IE 512 of FIG. 5A. The RRM information for the S-NSSAI can include one or more frequencies and associated priorities, for example, frequency 1 IE 544 at octet 9, frequency priority 1 IE 546 at octet 10, which corresponds to the priority of frequency 1 of the frequency 1 IE 544, frequency 2 IE 548 at octet 11, and frequency priority 2 IE 550 at octet 12, which corresponds to the priority of frequency 2 of the frequency 2 IE 548. The SRRMI IE 502c can comprise a plurality of frequency IEs to identify relevant frequencies and priorities for the S-NSSAI comprised in additional octets. SRRMI IE 502c can comprise S-NSSAI information for one or more S-NSSAI.

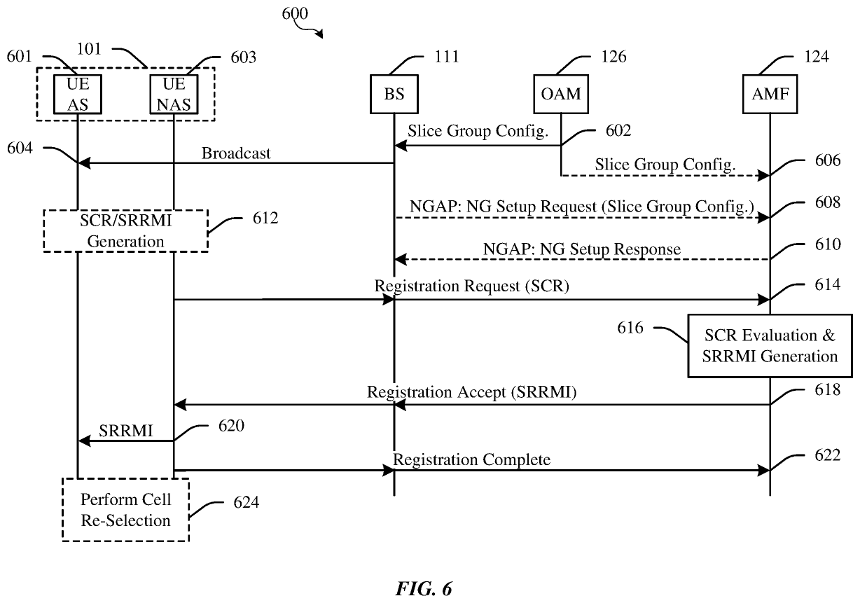

FIG. 6 is a signal flow diagram 600 outlining an example of slice based cell re-selection (SCR) signaling between a UE 101 and a network, in accordance with various aspects described herein. The signal flow diagram 600 describes signaling between several network devices and entities including a UE 101 comprising a UE AS 601 and UE NAS 603, a BS 111, an OAM entity 126, and an AMF 124. The network devices correspond to the network devices and entities described in FIG. 1.

At 602, the OAM entity 126 can send a configuration message to a BS 111 comprising a slice group configuration. In some examples, the slice group configuration is sent by an open mobile alliance device management (OMA-DM) management object or extensible markup language (XML) based scheme in an internet protocol (IP) message. The slice group configuration can be associated with one or more cells and comprises slice information corresponding to the SRRMI IE 502a of FIG. 5A. In some aspects, the slice group configuration can include one or more IEs of the SRRMI IE 502a of FIG. 5A. Subsequent description of the slice group configuration herein can be interpreted to include one or more IEs of the SRRMI IE 502a of FIG. 5A. The OAM entity 126 can also include RACH information associated with the slice group configuration at 602 where the RACH information can include a RACH configuration with the slice-specific RACH resource pool described in FIG. 5A.

In response to receiving the slice group configuration, the BS 111 can transmit a broadcast message at 604 to the UE AS 601. The broadcast message can include the slice group configuration which can include RACH information, from the OAM entity 126. The broadcast message can further indicate, supported slices in a cell and neighboring cell and network support for slice group and slice based cell re-selection procedures. The broadcast message can further indicate slice group identifier information associated with S-NSSAI group ID IE 508 of FIG. 5A. The slice group configuration also needs to be sent to the AMF 124. In one aspect, the OAM entity 126 can send the slice group configuration, which can include RACH information, to the AMF 124 at 606 directly. The OAM entity 126 can send the slice group configuration by an OMA-DM management object or extensible markup language (XML) based scheme in an internet protocol (IP) message. In this aspect, NGAP signaling is avoided. In an alternative aspect, the BS 111 can send a NG setup request according to a NGAP to the AMF 124 at 608 including the slice group configuration, which can comprise the RACH information. In response to receiving the NG setup request, the AMF 124 can transmit a NG setup response according to NGAP, to the BS 111 at 610 as an acknowledgement of receiving the NG setup request. As such, an initial slice group configuration is sent to the BS 111, UE 101, and AMF 124 according to the aspects described above, and thus further aspects can configure and communicate the SCR IE 304 and SRRMI IE 502a for SCR.

After the broadcast message is received by the UE 101 at 604, the UE 101 can determine UE 101 support for SCR and generate the SCR IE 304 according to the aspects and features of FIG. 3 or FIG. 4 at 612. The SCR IE 304 indicates capability to support cell re-selection based on network slicing and can be generated as part of a 5GMM capability IE and further indicate support for SCR while the UE 101 is in RRC idle state or RRC inactive state. At 612, the UE 101 can further generate the SRRMI IE 502a of FIG. 5A including one or more of the IEs described in accordance with FIG. 5A. The SRRMI IE 502a generated by the UE 101 can be referred to the UE SRRMI IE. The UE SRRMI IE can be generated according to the SCR IE 304, and can include slice information supported by the UE 101. The UE SSRMI IE can include a subset of SRRMI IEs, for example, the UE 101 may generate a number of S-NSSAI IE 504, S-NSSAI group ID IE 508, and supported S-NSSAI priority IE 510, and not generate other IEs. Generation of the SRRMI IE 502a is optional, and the UE 101 may not generate the UE SRRMI IE at 612 and may only generate the SCR IE 304.

At 614, the UE 101 generates and transmits a registration request to the BS 111 by the UE NAS 603. The BS 111, as the intermediate entity receives the REGISTRATION REQUEST message in RRC signaling from the UE 101, and forwards the REGISTRATION REQUEST message to the AMF 124. The registration request can include the SCR IE 304 generated by the UE 101, and can also include the UE SRRMI IE if the UE 101 generates the UE SRRMI IE. The registration request can be sent as an initial registration request, an initial registration request not associated with emergency services, as a mobility and periodic registration update (MRU) for example, when the UE 101 moves between cells. Furthermore, the registration request can be transmitted based on a change based event. For example, change based events can include one or more of a change between generations of wireless network technology (e.g. 4G and 5G transitions), a change in tracking area, a change in registration area, a change in protocol data unit (PDU) session), or a change in network slice configuration.

After receiving the registration request, the AMF 124 evaluates the SCR IE 304, the UE SRRMI IE if it is available, and generates a complete SRRMI IE at 616. The complete SRRMI IE can include one or more of the IEs in the SRRMI IE 502a of FIG. 5A. The AMF 124 can generate the complete SRRMI IE according to the capability information from the UE 101 in the SCR IE 304. The AMF 124 can further generate the complete SRRMI IE according to the SCR IE 304 and the UE SRRMI IE. In this aspect, the UE SRRMI IE may include all or a subset of the IEs described in FIG. 5A. The AMF 124 can generate the complete SRRMI IE to include some or all of the IE from the UE SRRMI IE, or the AMF 124 can consider the UE SRRMI IE and other network information, in conjunction with the SCR IE 304 to generate a complete SRRMI IE that is different from the UE SRRMI IE. In some aspects the UE SRRMI IE includes slice group and priority information and does not include RRM information thus the AMF 124 generates the RRM information associated with the SRRMI IE 502a of FIG. 5A. The complete SRRMI IE can be generated according to the aspects described in FIG. 5A.

After generating the complete SRRMI IE, the AMF 124 can generate and transmit a REGISTRATION ACCEPT message at 618 that includes the complete SRRMI IE. The REGISTRATION ACCEPT message can be received by the BS 111 and subsequently transmitted by the BS 111 to the UE NAS 603.

In response to receiving the REGISTRATION ACCEPT message, the UE NAS 603 communicates the complete SRRMI IE to the UE AS 601 at 620. If the UE 101 previously generated the UE SRRMI IE, the UE 101 can update the UE SRRMI IE with the complete SRRMI IE, and configure the complete SRRMI IE accordingly. In other aspects where the UE 101 did not generate the UE SSRMI IE, the UE 101 can configure the completed SRRMI IE.

Further, in response to receiving the REGISTRATION ACCEPT message, the UE 101 can generate and transmit a REGISTRATION COMPLETE message at 622 by the UE NAS 603 as an acknowledgment of receiving the REGISTRATION ACCEPT message. The REGISTRATION COMPLETE message can be sent to the BS 111 and the BS 111 can forward the REGISTRATION COMPLETE message to the AMF 124.

After transmitting the REGISTRATION COMPLETE message, the UE 101 can perform cell re-selection according to the complete SRRMI IE.

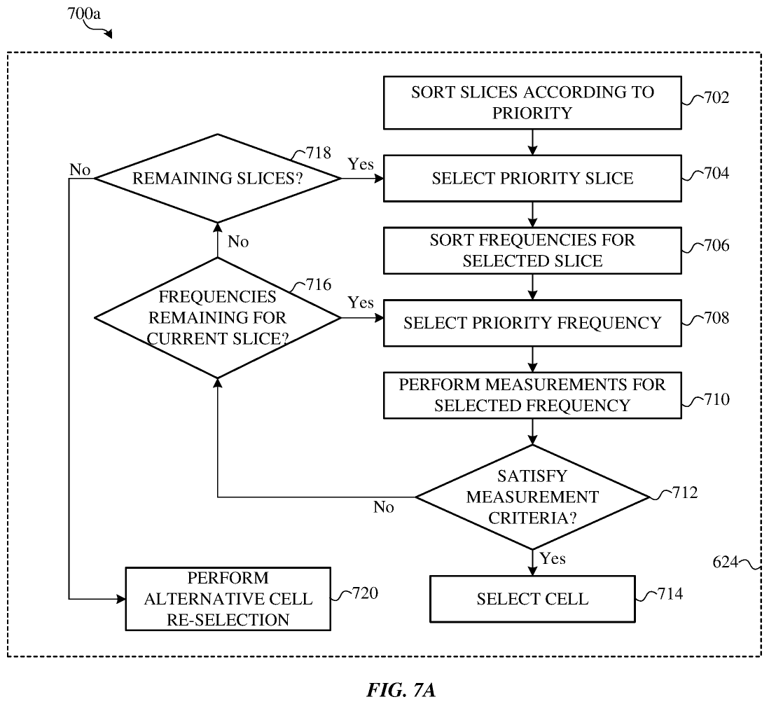

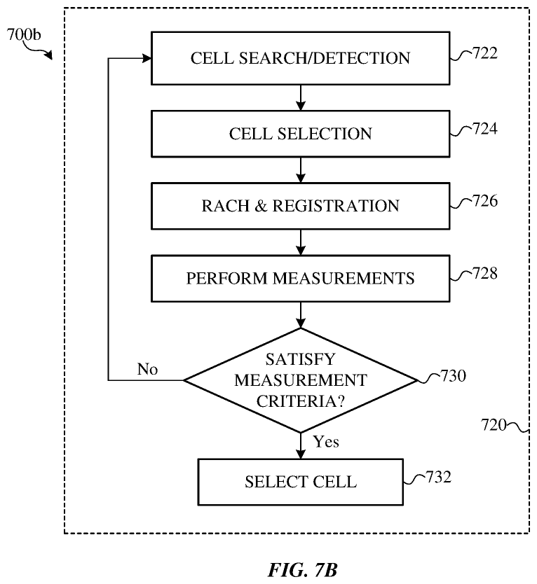

FIG. 7A illustrates a flow diagram 700a of a method for slice and frequency prioritization for SCR by a UE 101. Flow diagram 700a describes cell re-selection at 624 of FIG. 6.

After the UE NAS 603 communicates the complete SRRMI IE to the UE AS 601 at 620, the UE 101 can perform cell re-selection at 624 of FIG. 6. In response to the acts at 620, the UE 101 begins SCR by the UE AS 601 processing the complete SRRMI IE and sorting the slices from the complete SRRMI IE according to priority at 702. As such, the UE AS 601 processes the S-NSSAI priority IE 510, the number of S-NSSAI IE 504, the S-NSSAI value IE 506, and S-NSSAI group ID IE 508 of the complete SRRMI IE, and sorts the slices according to the S-NSSAI priority IE 510.

At 704 the UE AS 601 selects slices in priority order starting with the highest priority slice. At 706, the UE AS 601 sorts one or more frequencies associated with the selected slice from 704 according to the number of frequencies IE 512, the frequency value IE 514, and the associated frequency priority IE 516 of the complete SRRMI IE. At 708, the UE AS 601 selects frequencies in priority order starting with the highest priority frequency from 706 for the selected slice. At 710, the UE 101 performs measurements associated with the selected frequency from 708. The measurements can include beam measurements, signal measurements, quality measurements, and the like. At 712, the UE AS 601 determines if the selected frequency from 708 is suitable for cell re-selection based on the performed measurements at 710. For example, if the performed measurements satisfy a measurement criteria, then the selected frequency can be suitable for SCR. Thus if the measurement criteria from 712 is satisfied, then the UE 101 can select the cell associated with the selected slice at 704 and selected frequency at 708. In some aspects, the UE 101 can camp on the selected sell at 714.

If the selected frequency does not satisfy the measurement criteria at 712, then the UE AS 601 can determine if there is another priority frequency available for the selected slice at 716. The UE AS 601 can select a next prioritized frequency associated with the slice at 708 and continue the with performing measurements at 710 associated with the next prioritized frequency. For example, if a selected slice is associated with two frequencies, and a first priority frequency was selected and determined not to satisfy the measurement criteria, a second priority frequency can be selected at 708. The UE AS 601 then continues with the SCR process according to measurements associated with the second priority frequency at 710.

If there is not another priority frequency available for the selected slice according to the frequency sorting at 706, the UE AS 601 can determine if there is a remaining priority slice available at 718. If there is a remaining priority slice, the UE AS 601 can select the next priority slice at 704 according to the sorted slices at 702. For example, if there are two slices configured by the complete SRRMI IE, and the frequencies associated with a first slice do not satisfy the measurement criteria, then a second slice is selected according to the slice priority at 704 and the SCR process continues accordingly.

If there is not another priority slice available at 718, then the UE AS 601 can perform alternative cell re-selection according to other means at 720, for example, according to a legacy process, or some other cell re-selection process. Aspects of performing cell re-selection associated with 624 can apply to a single cell, multiple cells, or can occur on a per-cell basis. Furthermore, performing SCR associated with flow diagram 700A can occur while the UE 101 is in RRC_IDLE state or RRC_INACTIVE state. Lastly, aspects of cell re-selection of 624 can apply to sorting and selecting of slices and frequencies according to analogous IEs from SRRMI IE 502a of FIG. 5A, SRRMI IE 502b of FIG. 5B, or SRRMI IE 502c of FIG. 5C.

FIG. 7B illustrates a flow diagram 700b of a method for an alternative cell re-selection by a UE 101. Flow diagram 700b describes alternative cell re-selection at 720 of FIG. 7A.

After the UE 101 determines that there are no remaining slices at 718, the UE AS 601 can perform alternative cell re-selection according to other means, including the cell re-selection at 720 of FIG. 7B. At 722, the UE AS 601 can perform a cell search and detection processes to find new candidate cells. After detecting new cells, the UE AS 601 can select a candidate cell at 724. The UE AS 601 can perform a suitable RACH and registration procedure at 726 to register with the selected candidate cell. The UE AS 601 can perform cell re-selection measurements at 728 in response to performing the suitable RACH and registration procedure at 726. If the measurements of 728 satisfy a measurement criteria for cell re-selection at 730, then the UE 101 can select the candidate cell at 732. If the measurements of 728 do not satisfy the measurement criteria for cell re-selection at 730, then the UE 101 can return to 722 to conduct a subsequent cell search and detection process to find new candidate cells and continue the alternative cell re-selection process of 720.

FIGS. 6 and 5 shows SCR signaling with regards to some aspects of network and UE 101 signaling. In other aspects there are additional or alternative examples that relate to SCR described below.

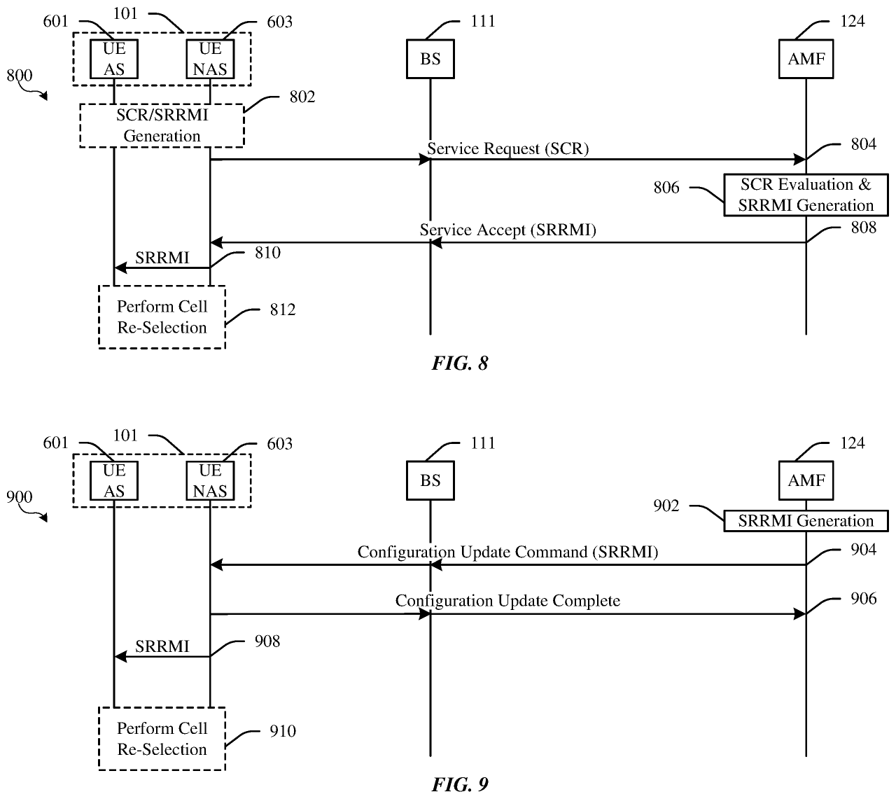

FIG. 8 is a signal flow diagram 800 outlining an example of a service request initiated by a UE 101 to update SRRMI information. The signal flow diagram 800 shows an alternative or additional SCR signaling in relation to FIG. 6.

In some aspects, the UE 101 will transition RRC states from an RRC_IDLE state or RRC_INACTIVE state to an RRC connected state and establish a radio bearer. Thus the UE 101 may benefit from having updated SRRMI information before RRC state switching to facilitate SCR. In some aspects, the UE 101 may have previously received SRRMI information from the network, for example according to the aspects described in FIG. 6, and may determine to initiate receiving updated SRRMI information from the network after a pre-defined amount of time or based on a trigger event. As such, the UE 101 has an opportunity to update the UE's 101 SRRMI configuration in case the configured SRRMI resources are stale, idle, inactive, or otherwise no longer available. Signal flow diagram 800 shows signaling that can provide the UE 101 with updated SRRMI information from the network.

At 802, the UE 101 can generate an updated SCR IE and optionally the UE SRRMI IE according to aspects of FIGS. 3 and 4 and at 612 of FIG. 6. At 804, the UE 101 can determine to generate and transmit, by the UE NAS 603, a service request to the BS 111. After receiving the service request, the BS 111 can transmit the service request to the AMF 124. The service request can include the updated SCR IE and optionally the UE SRRMI IE. At 806, the AMF 124 evaluates the updated SCR IE, the UE SRRMI IE if it is available, and generates a new completed SRRMI IE in response to receiving the service request at 804. The new completed SRRMI IE can be based on the updated SCR IE and the UE SRRMI IE if it is available. Aspects of 806 correspond to analogous aspects of 616 of FIG. 6 where the new complete SRRMI IE is analogous to the complete SRRMI IE of 616, the updated SCR IE is analogous to the SCR IE 304 of 616, and the UE SRRMI IE of FIG. 8 corresponds to the UE SRRMI IE of 616. At 808, the new completed SRRMI IE is generated and transmitted with a service accept message to the BS 111. After receiving the service accept message, the BS 111 transmits the service accept message to the UE NAS 603.

At 810, the UE NAS 603 sends the new completed SRRMI IE received in the service accept message to the UE AS 601 without any additional communications from the network. Aspects of 810 correspond to aspects of 620 of FIG. 6. At 812, the UE 101 can perform cell re-selection according to the new completed SRRMI IE. Aspects of 812 correspond to aspects of 624 of FIG. 6 and FIG. 7A and can include the slice and frequency prioritization in flow diagram 700a of FIG. 7A. As such, signal flow diagram 800 shows how the UE 101 can initiate a service request to receive updated SRRMI information to update any stale SRRMI information before conducting SCR.

FIG. 9 is a signal flow diagram 900 outlining an example of a configuration update command initiated by an AMF 124 to update SRRMI information. The signal flow diagram 900 shows an alternative or additional SCR signaling in relation to FIGS. 6 and 8.

In some aspects, after the UE 101 is configured with SRRMI resource from previous SRRMI related signaling with the network, for example, aspects described in FIG. 6 or 8, the SRRMI resources on the network side can change. For example, the network or AMF 124 may detect that slices become unavailable, overloaded, new slices are available, that previously rejected or unavailable slices become valid slices, that UE 101 subscription changes, or RRM information associated with network slices change, where the above aspects of changed slice resource information are in relation to a previously configured complete SRRMI IE. In this aspect, the AMF 124 may determine to send the UE 101 updated SRRMI information.

In an alternative aspect, the REGISTRATION COMPLETE message at 622 from the UE 101 may fail, and the AMF 124 may not receive the REGISTRATION COMPLETE message which serves as an acknowledgement that the UE 101 received the SRRMI associated with the REGISTRATION ACCEPT message at 618 of FIG. 6. In this aspect, the AMF 124 may determine that the REGISTRATION COMPLETE message fails when it is not received within a designated timeframe. In some aspects, the UE 101 may not receive the REGISTRATION ACCEPT at 618 of FIG. 6, and may not configure the complete SRRMI generated by the AMF 124. Accordingly, the UE 101 would not generate and transmit the REGISTRATION COMPLETE message at 622 of FIG. 6. In these aspects, the AMF 124 does not receive the REGISTRATION COMPLETE message at 622 of FIG. 6, and may determine that the UE 101 may not be configured with proper or updated SSRMI information. As a result, the AMF 124 may determine to send the UE 101 updated SRRMI information.

When the AMF 124 determines to send the UE 101 updated SRRMI information in relation to the aspects discussed above, the AMF 124 may generate an updated SRRMI IE at 902. Generating the updated SRRMI IE may include aspects discussed in relation to SRRMI generation at 616 of FIG. 6 where the updated SRRMI IE corresponds to the complete SRRMI IE at 616. In some aspects, the AMF 124 may generate the updated SRRMI IE using the SCR IE 304 from the UE 101 in the registration request at 614 of FIG. 6, or the updated SCR IE corresponding to a service request message at 804 of FIG. 8. In other aspects, the AMF 124 may generate the updated SRRMI IE without consideration of SCR IE information. In other aspects, the UE SRRMI IE from the UE 101 may be used by the AMF 124 in generating the updated SRRMI IE, where the UE SRRMI IE corresponds to aspects described at 612 of FIG. 6 or 802 of FIG. 8.

After generating the updated SRRMI IE, the AMF 124 may generate and transmit a configuration update command comprising the updated SRRMI IE at 904. The BS 111 receives the configuration update command and sends the configuration update command to the UE NAS 603. After receiving the configuration update command, the UE 101 generates and transmits a configuration update complete message, by the UE NAS 603, at 906. The configuration update complete message acknowledges the configuration update command. The configuration update complete message is received by the BS 111 and transmitted by the BS 111 to the AMF 124 at 906.

At 908, the UE NAS 603 communicates the updated SRRMI IE received in the configuration update command to the UE AS 601 without any additional communication from the network. Aspects of 908 correspond to aspects of 620 of FIG. 6. At 910, the UE 101 can perform cell re-selection according to the updated SRRMI IE. Aspects of 910 correspond to aspects of 624 of FIG. 6 and FIG. 7A and can include the slice and frequency prioritization in flow diagram 700a of FIG. 7A. As such, signal flow diagram 900 shows how the AMF 124 can initiate a configuration update command to update SRRMI information for the UE 101 before the UE 101 conducts SCR.

The aspects described above relate to slice grouping and prioritization for SCR as well as UE 101 and network signaling to accomplish SCR. Mechanisms by which network slices are grouped, prioritized, and mapped to associated frequencies to facilitate SCR are described as well as cell re-selection based on slice priorities and availability across cells in a battery power efficient and optimized manner.

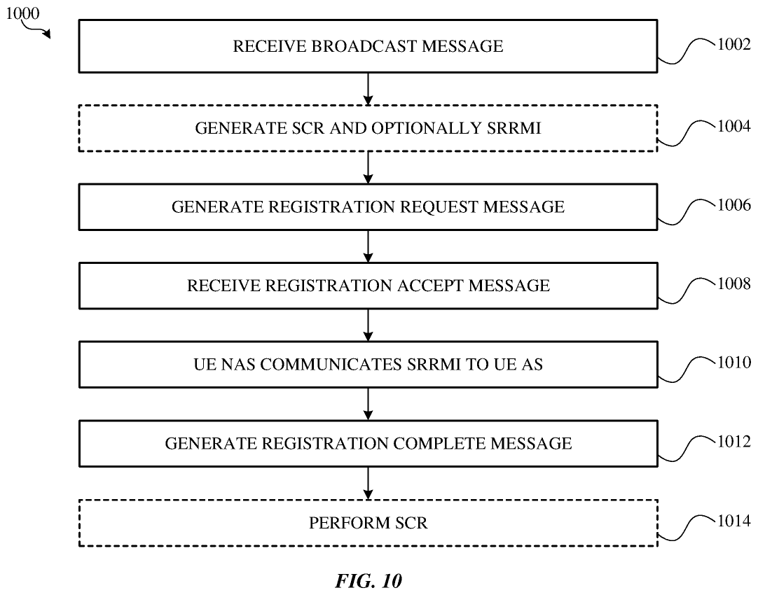

FIG. 10 illustrates a flow diagram of an example method 1000 for SCR signaling of a UE. The example method 1000 may be performed, for example, by the UE 101 of FIGS. 1 and 7.

At 1002, the method includes optionally receiving a broadcast message including a slice group configuration and optionally RACH information where the broadcast message indicates network support for slice group and slice based cell re-selection procedures. FIG. 6 at 604 corresponds to some aspects of act 1002.

At 1004, the method includes generating SCR capability information and optionally generating SRRMI associated with the SCR capability information where the SCR capability information indicates capability support for cell re-selection based on network slicing. FIG. 6 at 612 corresponds to some aspects of act 1004.

At 1006, the method includes generating a REGISTRATION REQUEST message that includes the SCR capability information in response to generating at least the SCR capability information. FIG. 6 at 614 corresponds to some aspects of act 1004.

At 1008, the method includes receiving a REGISTRATION ACCEPT message that includes a complete SRRMI IE in response to generating the registration request. FIG. 6 at 618 corresponds to some aspects of act 1008.

At 1010, the method includes a UE NAS of the UE communicating the complete SRRMI IE to a UE AS of the UE. FIG. 6 at 620 corresponds to some aspects of act 1010.

At 1012, the method includes generating a REGISTRATION COMPLETE message as an acknowledgement of receiving the REGISTRATION ACCEPT message. FIG. 6 at 622 corresponds to some aspects of act 1012. Act 1012 may occur before or after act 1010.

At 1014, the UE can optionally perform cell re-selection according to the complete SRRMI IE. FIG. 6 at 624 and FIG. 7A correspond to some aspects of act 1014.

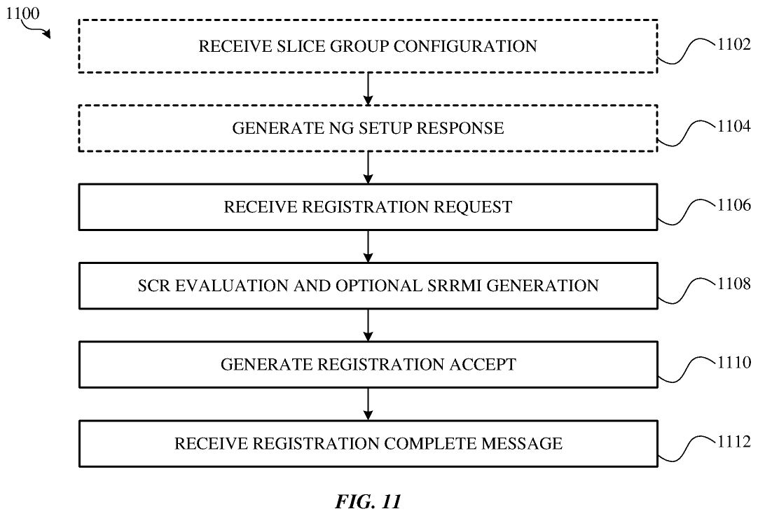

FIG. 11 illustrates a flow diagram of an example method 1100 for SCR signaling of an AMF. The example method 1100 may be performed, for example, by the AMF 124 of FIGS. 1 and 7.

At 1102, the method includes optionally receiving a slice group configuration where the slice group configuration may be received from an OAM entity of a network, or from a BS through a NG setup request according to NGAP. FIG. 6 at 606 and 608 corresponds to some aspects of act 1102.

At 1104, the method includes generating a NG setup response according to NGAP in response to optionally receiving the NG setup request. FIG. 6 at 610 corresponds to some aspects of act 1104.

At 1106, the method includes receiving a REGISTRATION REQUEST message that includes a SCR capability information and optionally includes SRRMI associated with the SCR capability information. FIG. 6 at 614 corresponds to some aspects of act 1104.

At 1108, the method includes evaluating the SCR capability information, and evaluating the associated SRRMI if it is present, and generating a complete SRRMI IE. FIG. 6 at 616 corresponds to some aspects of act 1108.

At 1110, the method includes generating a REGISTRATION ACCEPT message that includes the complete SRRMI IE. FIG. 6 at 618 corresponds to some aspects of act 1110.

At 1112, the method includes receiving a REGISTRATION COMPLETE message in response to generating the REGISTRATION ACCEPT message. FIG. 6 at 622 corresponds to some aspects of act 1112.

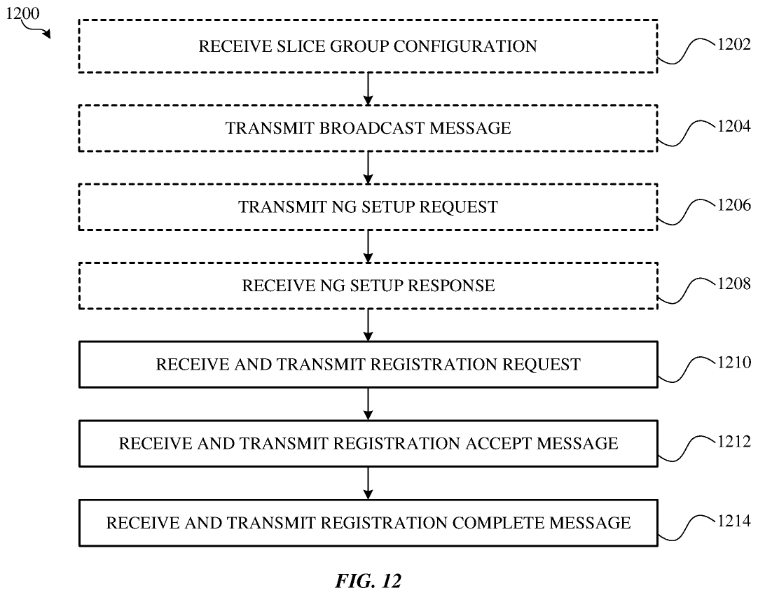

FIG. 12 illustrates a flow diagram of an example method 1200 for SCR signaling of a BS. The example method 1200 may be performed, for example, by the BS 111 of FIGS. 1 and 7.

At 1202, the method includes optionally receiving a slice group configuration from an OAM entity of a network. FIG. 6 at 602 corresponds to some aspects of act 1102.

At 1204, the method includes optionally generating a broadcast message that includes the slice group configuration and indicates network support for slice group and slice based cell re-selection procedures. The broadcast message may also include slice group IDs associated with the slice group configuration. FIG. 6 at 604 corresponds to some aspects of act 1204.

At 1206, the method includes optionally transmitting a NG setup request according to NGAP including the slice group configuration. FIG. 6 at 608 corresponds to some aspects of act 1204.

At 1208, the method includes receiving a NG setup response message in response to generating the NG setup request. FIG. 6 at 610 corresponds to some aspects of act 1208.

At 1210, the method includes receiving and then generating and transmitting a REGISTRATION REQUEST message that includes a SCR capability information and optionally includes SRRMI associated with the SCR capability information. FIG. 6 at 614 corresponds to some aspects of act 1210.

At 1212, the method includes receiving and then generating and transmitting a REGISTRATION ACCEPT message that includes a complete SRRMI IE. FIG. 6 at 618 corresponds to some aspects of act 1212.

At 1214, the method includes receiving and then generating and transmitting a REGISTRATION COMPLETE message in response to the REGISTRATION ACCEPT message. FIG. 6 at 622 corresponds to some aspects of act 1214.

FIG. 13 illustrates a flow diagram of an example method 1300 for a service request initiated by a UE to update SRRMI. The example method 1300 may be performed, for example, by the UE 101 of FIGS. 1 and 8.

At 1302, the method includes generating SCR capability information and optionally generating SRRMI associated with the SCR capability information where the SCR capability information indicates capability support for cell re-selection based on network slicing. FIG. 8 at 802 corresponds to some aspects of act 1302.

At 1304, the method includes generating a service request message that includes the SCR capability information in response to generating at least the SCR capability information. In some aspects, the service request message also includes the generates SRRMI. FIG. 8 at 804 corresponds to some aspects of act 1304.

At 1306, the method includes receiving a service accept message that includes a complete or updated SRRMI IE in response to generating the service request message. FIG. 8 at 808 corresponds to some aspects of act 1306.

At 1308, the method includes a UE NAS of the UE communicating the complete or updated SRRMI IE to a UE AS of the UE. FIG. 8 at 812 corresponds to some aspects of act 1308.

At 1310, the UE can optionally perform cell re-selection according to the complete SRRMI IE. FIG. 8 at 812 and FIG. 7A correspond to some aspects of act 1310.

FIG. 14 illustrates a flow diagram of an example method 1400 for AMF signaling associated with a service request to update SRRMI. The example method 1400 may be performed, for example, by the AMF 124 of FIGS. 1 and 8.

At 1402, the method includes receiving a service request message that includes a SCR capability information and optionally includes SRRMI associated with the SCR capability information. FIG. 8 at 804 corresponds to some aspects of act 1402.

At 1404, the method includes evaluating the SCR capability information, and evaluating the associated SRRMI if it is present, and generating a complete or updated SRRMI IE. FIG. 8 at 806 corresponds to some aspects of act 1404.

At 1406, the method includes generating a service accept message that includes the complete or updated SRRMI IE. FIG. 8 at 808 corresponds to some aspects of act 1406.

FIG. 15 illustrates a flow diagram of an example method 1500 for BS signaling associated with a service request to update SRRMI. The example method 1500 may be performed, for example, by the BS 111 of FIGS. 1 and 8.

At 1502, the method includes receiving and then generating and transmitting a service request message that includes a SCR capability information and optionally includes SRRMI associated with the SCR capability information. FIG. 8 at 804 corresponds to some aspects of act 1502.

At 1504, the method includes receiving and then generating and transmitting a service accept message that includes a complete or updated SRRMI IE. FIG. 8 at 808 corresponds to some aspects of act 1504.

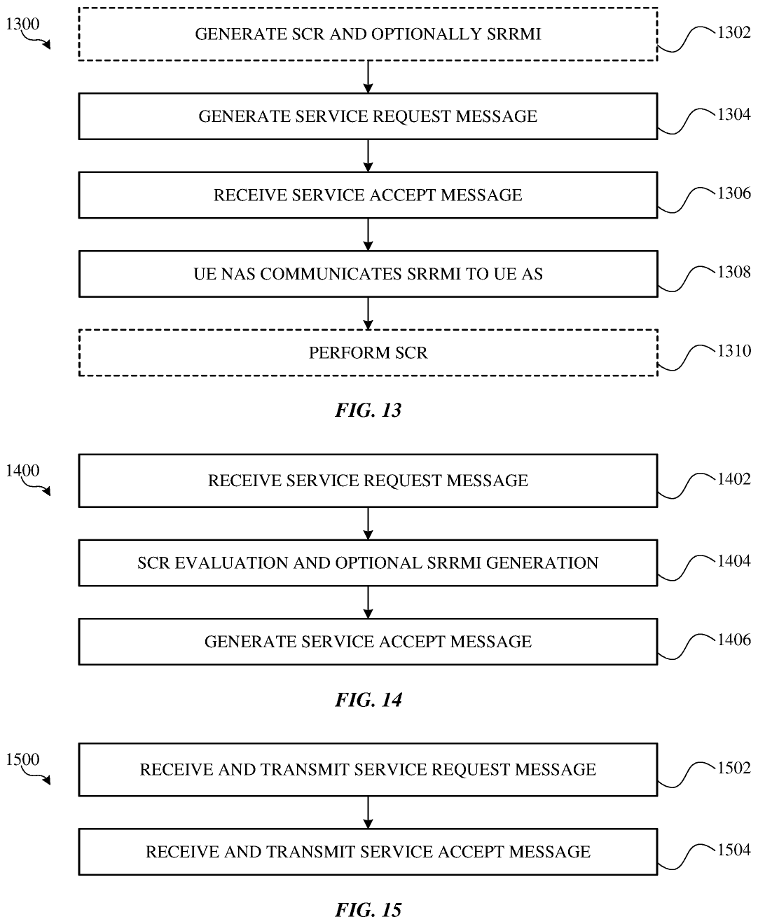

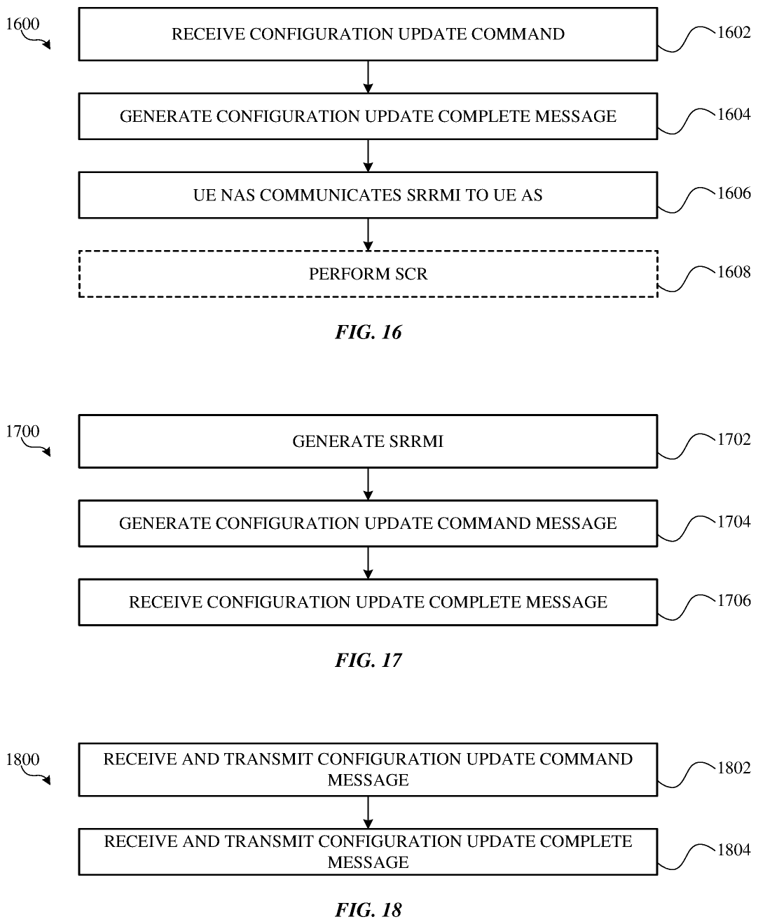

FIG. 16 illustrates a flow diagram of an example method 1600 for UE signaling associated with a configuration update command to update SRRMI. The example method 1600 may be performed, for example, by the UE 101 of FIGS. 1 and 9.

At 1602, the method includes receiving a configuration update command with a complete or updated SRRMI. FIG. 9 at 904 corresponds to some aspects of act 1602.

At 1604, the method includes generating a configuration update complete message in response to receiving the configuration update command. FIG. 9 at 906 corresponds to some aspects of act 1604.

At 1606, the method includes a UE NAS of the UE communicating the complete or updated SRRMI IE to a UE AS of the UE. FIG. 9 at 908 corresponds to some aspects of act 1606.

At 1608, the UE can optionally perform cell re-selection according to the complete or updated SRRMI IE. FIG. 9 at 910 and FIG. 7A correspond to some aspects of act 1608.

FIG. 17 illustrates a flow diagram of an example method 1700 for a service request to update SRRMI initiated by an AMF. The example method 1700 may be performed, for example, by the AMF 124 of FIGS. 1 and 9.

At 1702, the method includes generating an updated SRRMI IE. FIG. 9 at 902 corresponds to some aspects of act 1702.

At 1704, the method includes generating a configuration update command message that includes the updated SRRMI IE. FIG. 9 at 904 corresponds to some aspects of act 1704.

At 1706, the method includes receiving a configuration update complete message in response to generating the configuration update command message. FIG. 9 at 906 corresponds to some aspects of act 1706.

FIG. 18 illustrates a flow diagram of an example method 1800 for BS signaling associated with a configuration update command to update SRRMI. The example method 1800 may be performed, for example, by the BS 111 of FIGS. 1 and 9.

At 1802, the method includes receiving and then generating and transmitting a configuration update command message that includes an updated SRRMI. FIG. 9 at 904 corresponds to some aspects of act 1802.

At 1804, the method includes receiving and then generating and transmitting a configuration update complete message in response to generating and transmitting the configuration update command message. FIG. 9 at 906 corresponds to some aspects of act 1804.

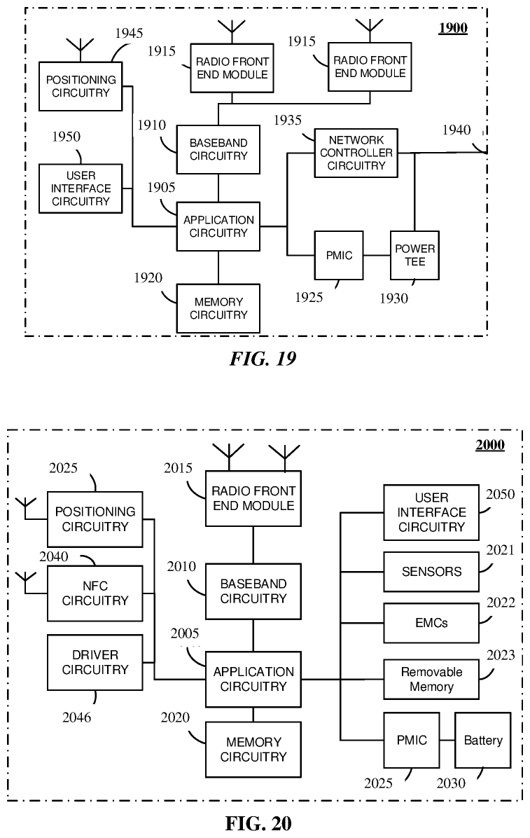

FIG. 19 illustrates an example of infrastructure equipment 1900 in accordance with various aspects. The infrastructure equipment 1900 (or “system 1900”) may be implemented as a base station, radio head, RAN node such as the BS 111 of FIG. 1 and/or any other element/device discussed herein. In other examples, the system 1900 could be implemented in or by a UE such as UE 101 of FIG. 1. In yet other aspects, some features of the system 1900 could be implemented in or by a AMF such as the AMF 124 of FIG. 1

The system 1900 includes application circuitry 1905, baseband circuitry 1910, one or more radio front end modules (RFEMs) 1915, memory circuitry 1920 (including a memory interface), power management integrated circuitry (PMIC) 1925, power tee circuitry 1930, network controller circuitry 1935, network interface connector 1940, satellite positioning circuitry 1945, and user interface 1950. In some aspects, the device of system 1900 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations. The baseband circuitry 1910 can be used to transmit one or more of slice group configuration by the OAM entity 126, transmit or re-transmit one or more of the broadcast message, registration request, registration accept, or registration complete messages by the BS 111, transmit the registration request, registration complete, service request, or configuration update complete messages by the UE 101, and or transmit the registration accept, service accept, or configuration update command by the AMF 124.

Application circuitry 1905 includes circuitry such as, but not limited to one or more processors (or processor cores), processing circuitry, cache memory, and one or more of low drop-out voltage regulators (LDOs), interrupt controllers, serial interfaces such as SPI, 120 or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1905 may be coupled with or may include memory/storage elements and may be configured to execute instructions stored in the memory/storage to enable various applications or operating systems to run on the system 1900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein. Application circuitry 1905 can generate and or facilitate updating one or more IEs associated with the 5GMM capability IE 302, the SRRMI IE 502a, 502b, or 502c, and S-NSSAI IEs for the UE 101 and or AMF 124. Memory circuitry 1920 can store one or more IEs associated with the 5GMM capability IE 302, the SRRMI IE 502a, 502b, or 502c, and S-NSSAI IEs for the UE 101 and or AMF 124.

The processor(s) of application circuitry 1905 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 1905 may comprise, or may be, a special-purpose processor/controller to operate according to the various aspects herein. As examples, the processor(s) of application circuitry 1905 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 1900 may not utilize application circuitry 1905, and instead may include a special-purpose processor/controller to process IP data received from an EPC or 5GC, for example. The application circuitry 1905 can be used to generate one or more of slice group configuration by the OAM entity 126, generate one or more of the broadcast message, registration request, registration accept, or registration complete messages by the BS 111, generate the registration request, registration complete, service request, or configuration update complete messages by the UE 101, and or generate the registration accept, service accept, or configuration update command by the AMF 124.

User interface 1950 may include one or more user interfaces designed to enable user interaction with the system 1900 or peripheral component interfaces designed to enable peripheral component interaction with the system 1900. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 19 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an 120 interface, an SPI interface, point to point interfaces, and a power bus, among others.

FIG. 20 illustrates an example of a platform 2000 (or “device 2000”) in accordance with various aspects. In aspects, the platform 2000 may be suitable for use as the UE 101 of FIG. 1, and/or any other element/device discussed herein such as the BS 111 or AMF 124 of FIG. 1. The platform 2000 may include any combinations of the components shown in the example. The components of platform 2000 may be implemented as integrated circuits (ICs), portions thereof, discrete electronic devices, or other modules, logic, hardware, software, firmware, or a combination thereof adapted in the platform 2000, or as components otherwise incorporated within a chassis of a larger system. The block diagram of FIG. 20 is intended to show a high level view of components of the platform 2000. However, some of the components shown may be omitted, additional components may be present, and different arrangement of the components shown may occur in other implementations.

Application circuitry 2005 includes circuitry such as, but not limited to one or more processors (or processor cores), memory circuitry 2020 (including a memory interface), cache memory, and one or more of LDOs, interrupt controllers, serial interfaces such as SPI, 120 or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 2005 may be coupled with or may include memory/storage elements and may be configured to execute instructions stored in the memory/storage to enable various applications or operating systems to run on the system 2000. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 2005 can facilitate generation of SCR/SRRMI messages for either the UE 101 or AMF 124, application circuitry 2005 can also facilitate performance of cell re-selection for the UE 101 associated with aspects of FIG. 7A at 624, as well as passing messaging between the UE AS 601 and UE NAS 603. Application circuitry 2005 can generate and or facilitate updating one or more IEs associated with the SGMM capability IE 302, the SRRMI IE 502a, 502b, or 502c, and S-NSSAI IEs for the UE 101 and or AMF 124. Memory circuitry 2020 can store one or more IEs associated with the SGMM capability IE 302, the SRRMI IE 502a, 502b, or 502c, and S-NSSAI IEs for the UE 101 and or AMF 124.

As examples, the processor(s) of application circuitry 2005 may include a general or special purpose processor, such as an A-series processor (e.g., the A13 Bionic), available from Apple® Inc., Cupertino, Calif. or any other such processor. The processors of the application circuitry 2005 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 2005 may be a part of a system on a chip (SoC) in which the application circuitry 2005 and other components are formed into a single integrated circuit, or a single package.

The baseband circuitry or processor 2010 may be implemented, for example, as a solder-down substrate including one or more integrated circuits, a single packaged integrated circuit soldered to a main circuit board or a multi-chip module containing two or more integrated circuits. Furthermore, the baseband circuitry or processor 2010 may cause transmission of various resources. Baseband circuitry or processor 2010 may facilitate, for example, reception of one or more of the broadcast message, registration accept message, service accept message, or configuration update command for the UE 101. Baseband circuitry or processor 2010 may facilitate, for example, transmission of one or more of the registration request, registration complete, service request, or configuration update complete message for the UE 101.

The platform 2000 may also include interface circuitry (not shown) that is used to connect external devices with the platform 2000. The interface circuitry may communicatively couple one interface to another. The external devices connected to the platform 2000 via the interface circuitry include sensor circuitry 2021 and electro-mechanical components (EMCs) 2022, as well as removable memory devices coupled to removable memory circuitry 2023.

A battery 2030 may power the platform 2000, although in some examples the platform 2000 may be mounted deployed in a fixed location, and may have a power supply coupled to an electrical grid. The battery 2030 may be a lithium ion battery, a metal-air battery, such as a zinc-air battery, an aluminum-air battery, a lithium-air battery, and the like. In some implementations, such as in V2X applications, the battery 2030 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 or AMF 124 of FIG. 1 can comprise a memory interface and processing circuitry or baseband processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: one or more processors configured to: determine support for slice based cell re-selection (SCR); generate a SCR information element (IE) that indicates capability support for cell re-selection based on network slicing; generate a registration request comprising the SCR IE in response to determining support for SCR; receive a REGISTRATION ACCEPT message comprising a slice radio resource management information (SSRMI) in response to generating the registration request; and generate a REGISTRATION COMPLETE message in response to receiving the SSRMI.

Example 2 can include Example 1, further configured to receive a broadcast message indicating network support for slice group and slice based cell re-selection procedures and generating the SCR IE in response to receiving the broadcast message.

Example 3 can include Example 2, wherein the broadcast message includes information of supported slices in current and neighboring cells.

Example 4 can include Example 1, wherein after receiving the REGISTRATION ACCEPT message, the SRRMI is communicated from a non-access stratum (NAS) protocol of the UE to an access stratum (AS) protocol of the UE.

Example 5 can include Example 1, wherein the registration request is sent as an initial registration request, a mobility and periodic registration update (MRU), or a change based event.

Example 6 can include Example 6, wherein the change based event is associated with a change between generations of wireless network technology, a change in tracking area, a change in registration area, change in protocol data unit (PDU) session, or a change in network slice configuration.

Example 7 can include Example 1, wherein the SCR IE is indicated by a single bit field in a fifth-generation of mobile telecommunications technology (5G) mobility management (MM) capability IE and further indicates support for SCR while the UE is in a radio resource control (RRC) idle (RRC_IDLE) state and RRC inactive (RRC_INACTIVE) state.

Example 8 can include Example 1, wherein the SCR IE is indicated in a fifth-generation of mobile telecommunications technology (5G) mobility management (MM) capability IE and further indicates support for SCR while the UE is in a radio resource control (RRC) idle (RRC_IDLE) state and RRC inactive (RRC_INACTIVE) state, wherein the SCR IE comprises: a slice grouping support IE indicting support for slice grouping; a slice priority support IE indicating support for slice prioritization; and a slice radio resource management (SRRM) support IE indicating support for SRRM configurations.

Example 9 can include Example 1, further configured to determine SRRMI including information elements (IEs) comprising one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, or a frequency priority associated with the S-NSSAI; and generating the registration request to include the IEs.

Example 10 can include Example 9, further configured to update the determined SRRMI with the SSRMI comprised in the REGISTRATION ACCEPT message.

Example 11 can include any of Examples 1 or 10, wherein the SSRMI comprised in the REGISTRATION ACCEPT message includes all of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI.

Example 12 can include any of Examples 9 or 11, wherein the S-NSSAI that are associated with a same frequency in a cell are grouped together and have a same S-NSSAI priority.

Example 13 can include any of Examples 9 or 11, wherein the S-NSSAI priority are based on an active application on the UE.

Example 14 can include any of Examples 1 or 11, further configured to: receive a configuration update command comprising SSRMI when the REGISTRATION COMPLETE message fails or in response to generating the REGISTRATION COMPLETE message; update the SSRMI comprised in the REGISTRATION ACCEPT message with the SSRMI comprised in the configuration update command; generate a configuration update complete message in response to receiving the configuration update command; and perform SCR based on the SSRMI comprised in the configuration update command wherein the SCR is performed by an access stratum (AS) protocol of the UE.

Example 15 can include any of Examples 1-14, further configured to perform SCR based on the SSRMI comprised in the REGISTRATION ACCEPT message, wherein the SCR is performed by an access stratum (AS) protocol of the UE.

Example 16 can include any of Examples 1-15, wherein the SCR is performed during a radio resource control (RRC) idle (RRC_IDLE) state or a RRC inactive (RRC_INACTIVE) state.

Example 17 is an access and mobility function (AMF) entity, configured to: receive a registration request comprising a slice based cell-reselection (SCR) information element (IE) that indicates capability of a user equipment (UE) to support cell re-selection based on network slicing; determine slice radio resource management information (SRRMI) comprising slice group configuration information in response to receiving the registration request; and transmit a REGISTRATION ACCEPT message comprising the SRRMI in response to determining the SRRMI.

Example 18 can include Example 17, further configured to receive a REGISTRATION COMPLETE message in response to generating the REGISTRATION ACCEPT message.

Example 19 can include any of Examples 17-18, wherein the SRRMI enables SCR between a UE and a base station (BS).

Example 20 can include any of examples 17-18, wherein the SRRMI is determined based on the SCR IE.

Example 21 can include Example 17, further configured to: receive a next generation (NG) setup request comprised in a NG application protocol (NGAP) signaling wherein the NG setup request includes an initial SRRMI comprising slice group configuration; transmit a NG setup response in response to receiving the NG setup request; receive the registration request after receiving the NG setup request; and determine the SRRMI based on the initial SRRMI.

Example 22 can include Example 21, wherein the NG setup request is received from a base station (BS).

Example 23 can include Example 21, wherein the NG setup request is received from an operation administration and maintenance (OAM) entity.

Example 24 can include Example 21, wherein the slice group configuration comprised in the initial SRRMI includes one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, or a frequency priority associated with the S-NSSAI.

Example 25 can include any of Examples 17-24, wherein the slice group configuration comprised in the determined SRRMI includes all of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI.

Example 26 can include Example 25, wherein the S-NSSAI that are associated with a same frequency in a tracking area (TA) or a registration area (RA) are grouped together and have a same S-NSSAI priority.

Example 27 can include Example 25, wherein the S-NSSAI priority are based on protocol data unit (PDU) session information and associated available network slices.

Example 28 can include Example 25, wherein the registration request includes SSRMI information elements (IEs) including one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI; and further configured to determine the SRRMI based on the SRRMI IEs included in the registration request.

Example 29 can include Example 17, wherein the registration request is received as an initial registration request or a mobility and periodic registration update (MRU).

Example 30 can include any of Examples 17-29, wherein the SCR IE is indicated by a single bit field in a fifth-generation of mobile telecommunications technology (5G) mobility management (MM) capability IE and further indicates support for SCR while a user equipment (UE) is in a radio resource control (RRC) idle (RRC_IDLE) state and RRC inactive (RRC_INACTIVE) state.

Example 31 can include any of Examples 17-29, wherein the SCR IE is indicated in a fifth-generation of mobile telecommunications technology (5G) mobility management (MM) capability IE and the SCR IE comprises: a slice grouping support IE indicating user equipment (UE) support for slice grouping; a slice priority support IE indicating UE support for slice prioritization; and a slice radio resource management (SRRM) support IE indicating UE support for SRRM configurations.

Example 32 can include claim 17, further configured to: transmit a configuration update command comprising updated SSRMI including updated slice group configuration information when a REGISTRATION COMPLETE message is not received within a timeframe or when the slice group configuration information of the determined SRRMI changes; and receive a configuration update complete message in response to generating the configuration update command.

Example 33 is a method of performing network group slice configuration, the method comprising: determining single network slice specific assistance (S-NSSA) grouping information; determining S-NSSA slice prioritization associated with the S-NSSA grouping information; and generating slice radio resource management information (SRRMI) comprising the S-NSSA grouping information and S-NSSA slice prioritization.

Example 34 can include Example 33, wherein the method is performed by an access and mobility function (AMF) of a core network (CN).

Example 35 can include Example 33, wherein the method is performed by a user equipment (UE).

Example 36 can include Example 33, wherein the S-NSSA grouping information is determined by grouping network slices available on a same frequency together.

Example 37 can include Example 36, wherein the S-NSSA grouping information is further determined by grouping network slices in a same tracking area (TA) or registration area (RA) together.

Example 38 can include any of Examples 36-37, wherein all network slices in a same group have a same priority and a slice priority of the same group becomes a single slice specific assistance information (S-NSSAI) priority.

Example 39 can include any of Examples 36-38, comprising determining a single slice specific assistance information (S-NSSAI) group ID associated with the determined S-NSSA grouping information, wherein the S-NSSAI group ID is based on a slice based cell re-selection (SCR) capability information of a user equipment (UE) and a subscription information of the UE.

Example 40 can include Example 33, wherein the S-NSSA slice prioritization is based on single slice specific assistance information (S-NSSAI) configuration of a user equipment (UE) and a priority of the S-NSSAI associated with a home public land mobile network (HPLMN) status or visited public land mobile network (VPLMN) status of the UE.

Example 41 can include Example 33, wherein the S-NSSA slice prioritization is based on active applications running on a user equipment (UE).

Example 42 can include Example 33, wherein the S-NSSA slice prioritization is based on protocol data unit (PDU) session information and associated available network slices.

Example 43 can include Example 33, wherein the S-NSSA slice prioritization is based on a priority of an active application running on a user equipment (UE) and user plane traffic associated with the UE.

Example 44 can include Example 33, wherein the S-NSSA slice prioritization is based on network slice overload information in a tracking are (TA) or registration area (RA).

Example 45 can include Example 33, wherein the S-NSSA slice prioritization is based on a single slice specific assistance information (S-NSSAI) inclusion mode.

Example 46 can include Example 33, wherein the S-NSSA slice prioritization is based on a random access channel (RACH) configuration.

Example 47 can include Example 33, wherein the S-NSSA slice prioritization is based on any of the methods of Examples 41-46.

Example 48 can include any of Examples 33-47, further comprising: determining one or more information elements (lEs) including a number of single network slice specific assistance information (S-NSSAI), a S-NSSAI value based on the S-NSSA grouping information, a S-NSSAI group ID associated with the S-NSSAI value, a S-NSSAI priority based on the S-NSSA slice prioritization, a number of frequencies supported by the S-NSSAI, a frequency value associated with the S-NSSAI, or a frequency priority associated with the S-NSSAI; and generating the SRRMI with the IEs.

Example 49 is a baseband processor of a base station (BS), comprising: one or more processors configured to: receive a registration request comprising a slice based cell re-selection (SCR) information element (IE) that indicates capability of a user equipment (UE) to support cell re-selection based on network slicing; transmit a REGISTRATION ACCEPT message comprising slice radio resource management information (SRRMI) including slice group configuration information in response to receiving the registration request; and receive a REGISTRATION COMPLETE message in response to transmitting the REGISTRATION ACCEPT message.

Example 50 can include Example 49, further configured to: generate a next generation (NG) setup request according to a NG application protocol (NGAP) wherein the NG setup request includes an initial SRRMI including slice group configuration; receive a NG setup response in response to generating the NG setup request; and transmit the registration request after receiving the NG setup request.

Example 51 can include any of Examples 49-50, further configured to: receive a slice group configuration message from an operation administration and maintenance (OAM) entity indicating network support for slice based cell re-selection procedures; and generate a broadcast message including the slice group configuration message before receiving the registration request.

Example 52 can include Example 51, wherein the slice group configuration message is associated with random access channel (RACH) information.

A method as substantially described herein with reference to each or any combination substantially described herein, comprised in examples 1-51, and in the Detailed Description.

A non-transitory computer readable medium as substantially described herein with reference to each or any combination substantially described herein, comprised in examples 1-51, and in the Detailed Description.

A wireless device configured to perform any action or combination of actions as substantially described herein, comprised in examples 1-51, and in the Detailed Description.

An integrated circuit configured to perform any action or combination of actions as substantially described herein, comprised in examples 1-51, and in the Detailed Description.

An apparatus configured to perform any action or combination of actions as substantially described herein, comprised in examples 1-51, and in the Detailed Description.

A baseband processor configured to perform any action or combination of actions as substantially described herein, comprised in examples 1-51, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband processor of a user equipment (UE), comprising:
one or more processors configured to cause the UE to:
determine support for slice based cell re-selection (SCR);
generate a SCR information element (IE) that indicates capability support for cell re-selection based on network slicing;
transmit a registration request comprising the SCR IE in response to determining support for SCR;
receive a REGISTRATION ACCEPT message comprising a slice radio resource management information (SSRMI) in response to transmitting the registration request; and
transmit a REGISTRATION COMPLETE message in response to receiving the SSRMI.

2. The baseband processor of claim 1, wherein after receiving the REGISTRATION ACCEPT message, the SRRMI is communicated from a non-access stratum (NAS) protocol of the UE to an access stratum (AS) protocol of the UE.

3. The baseband processor of claim 1, wherein the registration request is sent as an initial registration request, a mobility and periodic registration update (MRU), or a change based event.

4. The baseband processor of claim 1, wherein the SCR IE is indicated by a single bit field in a fifth-generation of mobile telecommunications technology (5G) mobility management (MM) capability IE and further indicates support for SCR while the UE is in a radio resource control (RRC) idle (RRC_IDLE) state and RRC inactive (RRC_INACTIVE) state.

5. The baseband processor of claim 1, wherein the SCR IE is indicated in a fifth-generation of mobile telecommunications technology (5G) mobility management (MM) capability IE and further indicates support for SCR while the UE is in a radio resource control (RRC) idle (RRC_IDLE) state and RRC inactive (RRC INACTIVE) state, wherein the SCR IE comprises:
a slice grouping support IE indicting support for slice grouping;
a slice priority support IE indicating support for slice prioritization; and
a slice radio resource management (SRRM) support IE indicating support for SRRM configurations.

6. The baseband processor of claim 1, further configured to determine SRRMI including information elements (lEs) comprising one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, or a frequency priority associated with the S-NSSAI; and
generating the registration request to include the IEs.

7. The baseband processor of claim 6, further configured to update the determined SRRMI with the SSRMI comprised in the REGISTRATION ACCEPT message.

8. The baseband processor of claim 1, wherein the SSRMI comprised in the REGISTRATION ACCEPT message includes all of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI.

9. A user equipment (UE), comprising:
a memory; and
one or more processors configured to, when executing instructions stored in the memory, cause the UE to:
transmit a REGISTRATION COMPLETE message in response to receiving a slice radio resource management information (SSRMI);
receive a configuration update command comprising an updated SSRMI;
update the SSRMI with the updated SSRMI comprised in the configuration update command;
transmit a configuration update complete message in response to completing the SSRMI update; and
perform slice based cell re-selection (SCR) based on the updated SSRMI wherein SCR is performed by an access stratum (AS) protocol of the UE.

10. An access and mobility function (AMF) entity, configured to:
receive a registration request comprising a slice based cell-reselection (SCR) information element (IE) that indicates capability of a user equipment (UE) to support cell re-selection based on network slicing;
determine slice radio resource management information (SRRMI) comprising slice group configuration information in response to receiving the registration request; and
transmit a REGISTRATION ACCEPT message comprising the SRRMI in response to determining the SRRMI.

11. The AMF entity of claim 10, further configured to receive a REGISTRATION COMPLETE message in response to generating the REGISTRATION ACCEPT message.

12. The AMF entity of claim 10, wherein the SRRMI enables SCR between a UE and a base station (BS).

13. The AMF entity of claim 10, wherein the SRRMI is determined based on the SCR IE.

14. The AMF entity of claim 10, wherein the slice group configuration information includes one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, or a frequency priority associated with the S-NSSAI.

15. The AMF entity of claim 14, wherein the slice group configuration information comprised in the determined SRRMI includes all of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI.

16. The AMF entity of claim 15, wherein the S-NSSAI that are associated with a same frequency in a tracking area (TA) or a registration area (RA) are grouped together and have a same S-NSSAI priority.

17. The AMF entity of claim 15, wherein the S-NSSAI priority are based on protocol data unit (PDU) session information and associated available network slices.

18. The AMF entity of claim 15, wherein the registration request includes SSRMI information elements (IEs) including one or more of a number of single network slice specific assistance information (S-NSSAI), a S-NSSAI value, a S-NSSAI group ID, a S-NSSAI priority, a number of frequencies associated with the S-NSSAI, a frequency value associated with the S-NSSAI, and a frequency priority associated with the S-NSSAI; and
further configured to determine the SRRMI based on the SRRMI IEs included in the registration request.

19. The AMF entity of claim 10, wherein the registration request is received as an initial registration request or a mobility and periodic registration update (MRU).

20. The AMF entity of claim 10, wherein the SCR IE is indicated by a single bit field in a fifth-generation of mobile telecommunications technology (5G) mobility management (MM) capability IE and further indicates support for SCR while a user equipment (UE) is in a radio resource control (RRC) idle (RRC_IDLE) state and RRC inactive (RRC_INACTIVE) state.
